(19) United States
(12) Patent Application Publication
(10) Pub. No.: US 2003/0154107 A1
(43) Pub. Date: Aug. 14, 2003

(54) Preventcare

(76) Inventor: Mark Medvedeff, Akron, OH (US)

Correspondence Address: Roger D. Emerson, Brouse McDowell, 500 First National Tower, 106 S. Main Street, Akron, OH, 44308-1471, US

(21) Appl. No.: 10/367,471

(22) Filed: Feb. 14, 2003

Related U.S. Application Data
(60) Provisional application No. 60/357,470, filed on Feb. 14, 2002.

(51) Int. Cl. G06F 17/60; G06G 7/00; G06F 17/00; G09B 19/00

(52) U.S. Cl. 705/2; 705/400; 434/107; 434/118

(57) ABSTRACT

To provide a preventive health care plan for a group of people, where the health care plan evaluates the generally un-sick health status of the members of the group and develops a personalized preventive health care plan that when followed substantially reduces or postpones major illness of those engaging in the personalized health care plan thereby reducing health care costs and employee absenteeism due to major illnesses.

This application claims priority from a U.S. Provisional patent application, serial No. 60/357,470, filed Feb. 14, 2002.

### BACKGROUND OF THE INVENTION

A. Field of Invention

This invention pertains to the field preventive health care and more specifically to a method of providing preventive health care to reduce the costs of major illnesses.

B. Description of the Related Art

It is known to provide preventive treatment to avoid the onset of various diseases. For many years medical personnel have researched the causes of more serious ailments in hopes of finding a cure or a means to prevent the major ailments altogether. More recently research has been and is being conducted on causes of developing cancer and heart disease, which rate among the highest fatal diseases in the world. Much of the research being conducted relates to the treatment of such disease once it has been detected in a patient. The costs for treating such diseases extend into the hundreds of millions of dollars.

It would be advantageous to provide a solution to reduce the onset of such major illnesses, as well as other minor illnesses, which would naturally reduce the costs associated with treating such illnesses. One such method of preventing major illness, like cancer, relates to the free radical theory of medicine. The free radical theory of medicine relates the tendency to developing a disease such as a cancer at least in part to the level of free radicals present in the body. As a result, studies have been conducted on reducing the levels of free radicals in the body. The reduction of free radicals may be accomplished according to some studies by ingesting certain types and quantities of vitamins and minerals. This has led to the shotgun approach of consuming excessive amounts of a broad range of nutrients such as vitamins and minerals. However, the consumption of excessive quantities of such nutrients may not be beneficial to the reduction of free radicals and the prevention of diseases related thereto such as cancer. Furthermore, consumption of certain nutrients may prove detrimental to the health of an individual based upon health profile factors, such as smoking for example.

What is needed is a method of providing preventive care for improving the wellness condition of a person by the recommendation of non-prescription substances in specific quantities and types as related to the specific health profile of an individual.

### SUMMARY OF THE INVENTION

According to one aspect of the present invention, a method is provided for reducing health care costs.

Another aspect of the present invention involves sending a preventive health care technician to a place of normal of activity, business, personal or otherwise, to conduct preventive health care activities.

Yet another aspect of the present invention is to develop an individualized plan for a each person on a group of people receiving preventive health care.

Still another aspect of the present invention is to test the wellness of an individual and develop a preventive health care plan based on the results of testing.

Still yet another aspect of the present invention is to educate the person receiving preventive health care regarding the results of wellness testing.

Even still another aspect of the present invention is to implement individualized preventive health care programs that have been developed based upon the results of wellness testing so that the certain ailments associated with level of free radicals in the body may be deterred or eliminated thereby reducing health care costs in a group of people.

There is provided a method for providing preventive health care that includes sending a preventive health care technician to the site of the preventive health care recipient. In the method, the technician, who may be a physician, administers a wellness test to ascertain the wellness condition of the recipient. An individualized plan is developed based on the testing results and communicates the details of the plan back to the recipient, wherein the preventive health care technician educates the recipient as how to implement the details of the individualized plan for improving the wellness state of the recipient. The provider of the preventive health care plan may contract with organizations or individuals to underwrite the plan to be enacted upon a predetermined group of individuals or single individual.

Still other benefits and advantages of the invention will become apparent to those skilled in the art to which it pertains upon a reading and understanding of the following detailed specification.

### BRIEF DESCRIPTION OF THE DRAWINGS

The invention may take physical form in certain parts and arrangement of parts, a preferred embodiment of which will be described in detail in this specification and illustrated in the accompanying drawings which form a part hereof and wherein:

FIG. 1 is a schematic representation of a human body.

FIG. 2 is a chart showing the present method of providing preventive health care.

FIG. 3 is a sample questionnaire.

FIG. 3a is the second page of the sample questionnaire.

FIG. 4 is a sample recommended preventive care plan.

FIG. 4a is a sample recommended preventive care plan.

FIG. 4b is a sample recommended preventive care plan.

FIG. 4c is a sample recommended preventive care plan.

FIG. 4d is a sample recommended preventive care plan.

FIG. 5 is a schematic representation of the preventive care entity, insuring entity, primary health care provider and organization enrolled in the preventive care wellness program.

FIG. 5a is a schematic representation of the preventive care entity, provider of ingredients and person enrolled in the preventive care wellness program.

### DESCRIPTION OF THE PREFERRED EMBODIMENT

By way of illustrating a more complete appreciation of the present invention, the following detailed description and examples are given concerning the novel method of providing a preventive care wellness plan. Referring now to the drawings wherein the showings are for purposes of illustrating a preferred embodiment of the invention only and not for purposes of limiting the same, FIG. 1 shows a representation of a human body 1. The human body 1 may from time to time experience illness such as influenza and the common cold. People also develop more serious ailments such cancer and heart disease. In the course of normal living, certain factors have been shown to play a significant role in the development of such major illnesses. Some of the factors that affect the onset of major illness involve life style choices, while other factors are more hereditary in nature. As people become ill they are apt to seek diagnosis and treatment from a medical doctor that has expertise in the area concerning their particular ailment. It is noted at this point that the U.S. Provisional patent application, serial No. 60/357,470 filed on Feb. 14, 2002 from which this subject application claims priority is incorporated by reference into this patent application.

As research has been and is being done in the area of disease prevention, still very little has been accomplished to implement an individualized disease prevention program. The present invention relates to a method of providing preventive health care that is tailored to meet the individual preventive care needs of people. In this manner, preventive health care may be more affective than currently known methods by clearly identifying preventive care factors specific to the individual. This provides the individual with the critical knowledge needed to make healthy lifestyle choices especially in light in their family medical history.

The method of providing preventive health care as presently detailed requires a medically trained physician skilled in examining existing bodily conditions, such as cholesterol ratios, body mass, free radicals, blood sugars and the like and prescribing a course of preventive care action based on such data. In the preferred embodiment, the method of providing preventive care or the preventive care plan includes: gathering individualized medical data about each person involved in the preventive care program, testing for physical bodily conditions and levels, evaluating the individualized data to determine the wellness condition of the person, developing or prescribing an individualized plan for each person respectively based on the results of the gathering phase and testing phase, and then communicating the plan to the individual along with educating them on various aspects of implementing the plan.

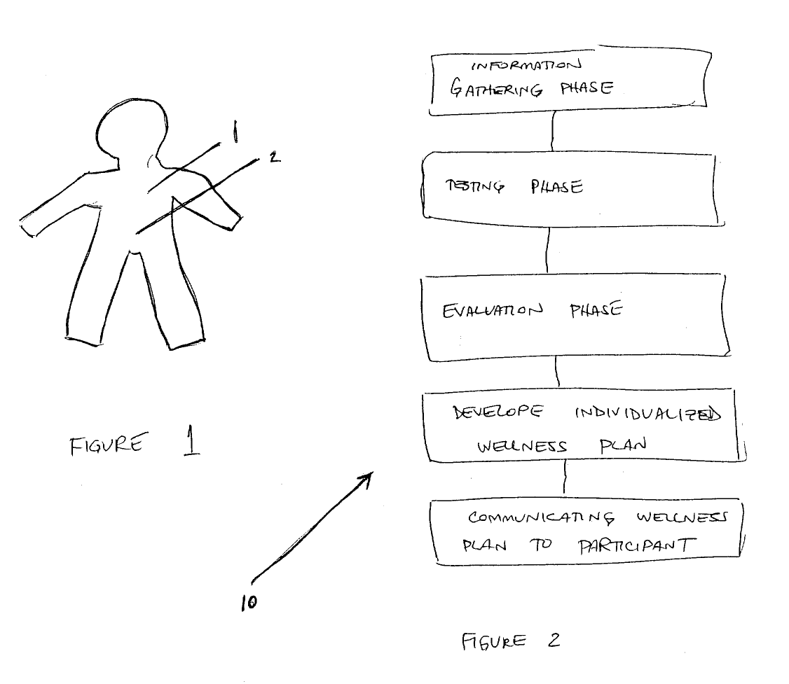

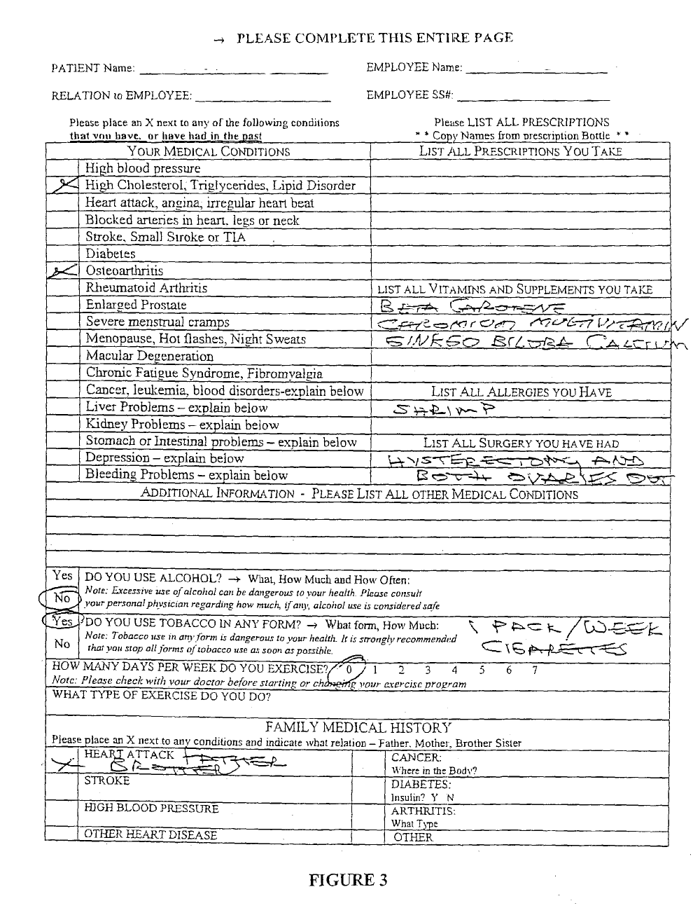

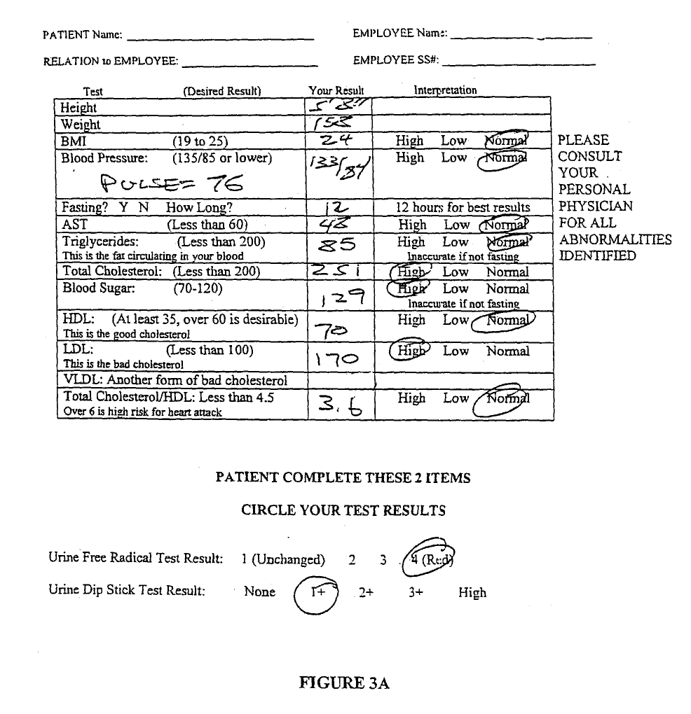

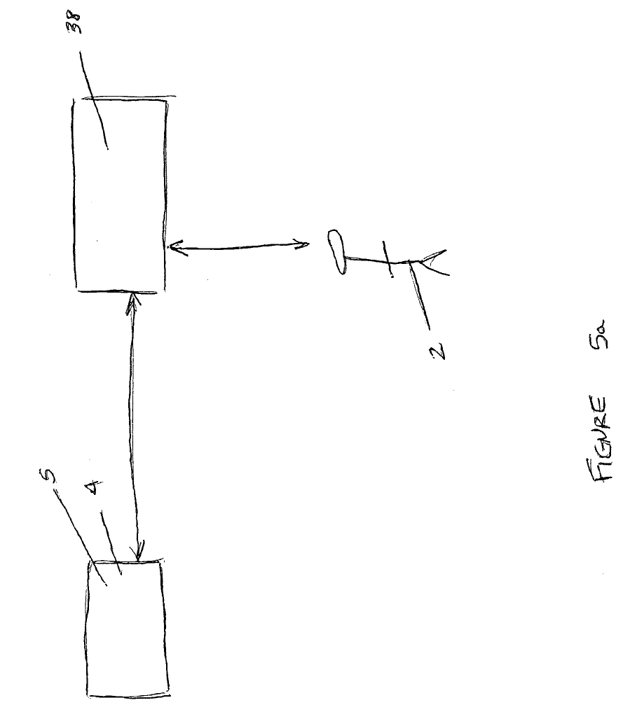

FIG. 2 schematically outlines the flow of the method of the present invention. It is noted that the person 2 or persons 2 participating in the program of the present invention may be referred to as the preventive care participant. A preventive care technician 29, shown in FIG. 5, is provided, which may be a physician, doctor's assistant, nurse or any person apt to understanding medical terminology that can administer medical tests as described in the present application. With specific reference now to the first phase, the gathering phase, of the present method of providing preventive health care, the preventive care technician travels to the place of normal activity of the person enrolled and participating in the program of the present invention, in other words the preventive care participant. The place of normal activity may be normal business activity such as in an office setting, manufacturing work place, home, or other designated location. However, any place where a participant carries out their normal routine activities may be construed to mean the place of normal business activity. Traveling to the place of normal business activity is important in providing convenience access for the participant to the preventive care program. This will help to maximize participation from any given group of individuals 2 that may be enrolled in the preventive care program. Furthermore, maximizing participation results in increased reductions in the overall, long term costs for medical treatment, as directly related to the onset of major illness. The preventive care technician may provide a medical history data questionnaire for the preventive care participants to complete, which may include questions relating to current personal medical data, personal historical data and family or hereditary medical information. An example questionnaire is shown in FIGS. 3 and 3a. However, it is expressly noted that any type of personal data may be included on the questionnaire chosen with sound medical judgment as is appropriate for use in a preventive health care program such as is described herein. In the preferred embodiment, the questionnaire is distributed prior to the visit by the preventive care technician allowing time for the preventive care participant to answer the questions contained therein. In this manner, the technician may be available to answer questions that the participant may have as well as to ensure to completeness and accuracy of the information provided. However, it is noted that the questionnaire may be completed during the scheduled visit by the technician or even thereafter as may be necessary.

At the place of normal business activity, the technician may administer one or more tests to determine various physiological conditions of the preventive care participant. These tests may include urine test to test for the level of free radicals in the participant's body and a blood test to determine the ratio of HDL to LDL cholesterol in the participant's body, blood sugar levels or any medically pertinent data necessary to the evaluation of the wellness condition of the participant. It is further noted that any type of test may be administered as chosen with sound judgment as is appropriate for evaluating the wellness condition of the preventive care participant. By wellness condition it is meant, the state of the body to fight the onset of disease, especially as related to major illness. In that the wellness condition of the human body is known in the art, no further explanation will offered at this point.

With reference now to the evaluating phase of the present method of providing preventive health care, the gathering-phase data, including the questionnaire data and testing results, may be amassed for evaluation and given to the preventive care physician. Any manner of amassing the information for submission to the preventive care physician may be chosen with sound medical and business judgment. Having had initially completed assembling the data from the gathering phase, the preventive care physician may examine the individualized data for significant risk factors associated with the participant's health profile. That is to say that the preventive care physician would evaluate the participant's risk factor for developing a major illness based on results of the information amassed during the gathering phase and testing phases. For example, the questionnaire may inquire as to the participant's family history of developing lung cancer, of which one answer to the questionnaire may have indicated such a family history. Additionally, the level of free radicals, as shown from the free radical test, may indicate above normal threshold levels of free radicals in the participant's body. In such a case, the preventive care physician may prescribe or recommend that the participant ingest, on a periodic basis, beta-carotene in quantities consistent with individualized physiological factors, such as the participant's body mass. One key factor is presently noted, specifically that a prescription or recommendation to ingest beta-carotene is known to be detrimental to a person's health, in the event that the person is currently using a tobacco product. For this reason and in this manner, the preventive care physician examines all of the data gathered in the gathering and testing phases and evaluates a recommendation that is consistent with the wellness and health of the participant. If the participant should have indicated that they currently use tobacco products, the preventive care physician would have prescribed an alternate plan consistent with the participant's health profile. The preventive care physician is not intended to replace existing primary health care but is instead designed to augment existing primary health care by communicating health profile information about the participant to the participant's primary health care giver. In this manner, the preventive care physician and the primary health care giver work in conjunction with and not in opposition to the other, which results in an increased wellness condition of the participant.

As the preventive care physician evaluates the participant's wellness data, the preventive care physician may formulate a list of activities or a plan, as mentioned above, for the participant to implement as a means for improving the wellness condition of the participant. The list of activities or plan may include: exercise of various kinds, abstinence from consuming certain elements at certain times and the routine ingestion of non-prescription substances such a vitamin and minerals, each in specific quantities or amounts as related to the wellness condition of the participant. However, any activity consistent with improving the wellness condition of a participant, as related to the results of the data amassed from the gathering and testing phases, may be prescribed or recommended as chosen with sound medical judgment. Because of the possible interaction of substances as related to the participant's wellness condition and any detrimental affects stemming there from, it is necessary that a physician or equivalently trained medical person perform the evaluation, analysis and formulation of this portion of the present method of providing preventive health care. In other words, the evaluation and formulation of a wellness plan may only be performed by a person medically trained in the field of preventive health care. In this manner, the health of an individual is considered while they are being assessed for preventive care treatment. It is noted that in the event that an illness is discovered, the preventive care physician may not treat or recommend treatment for the illness discovered but may refer the participant to their primary health care giver for treatment of the illness. The participant may then return to the activities prescribed under the preventive care plan after sufficient medical treatment for the illness has been completed. This is an important note because the purpose of the preventive care plan is to prevent the onset of serious or major illnesses not the treatment of existing illness. One unique aspect to the present method of providing preventive health is that the preventive care plan or wellness plan is individualized. That is to say that the plan is custom tailored specifically to every participant based on the results of the data from the gathering and testing phases. In other words, the activities of the plan may differ from every other participant in the preventive care program because each participant possesses a different health profile. This is clearly distinguished from other methods of providing preventive care that categorize individuals into classes or groups and prescribe preventive treatment based upon the factors in that particular group.

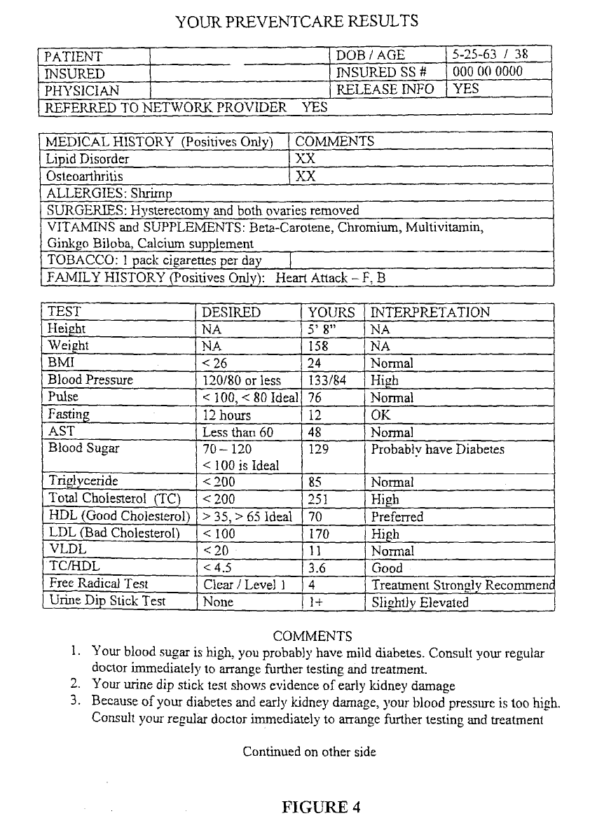

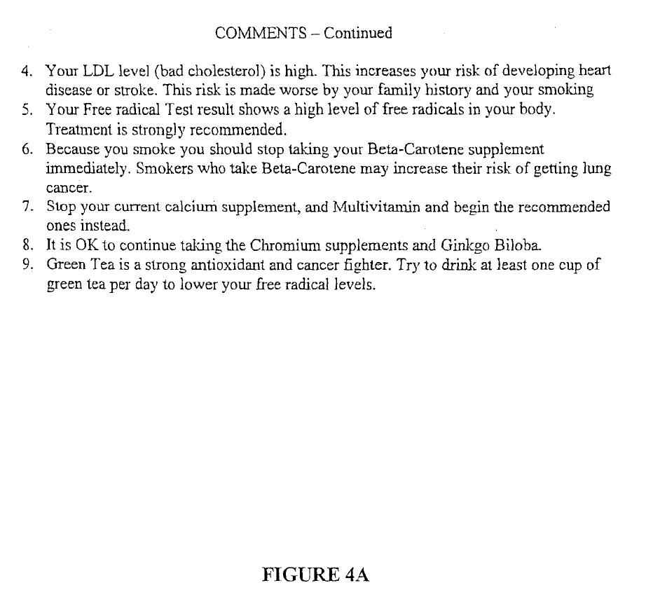

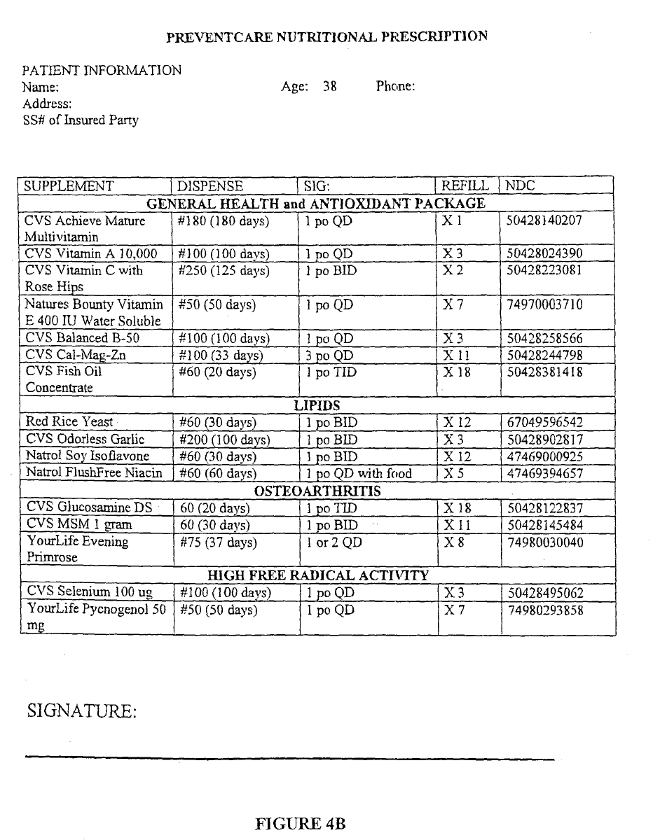

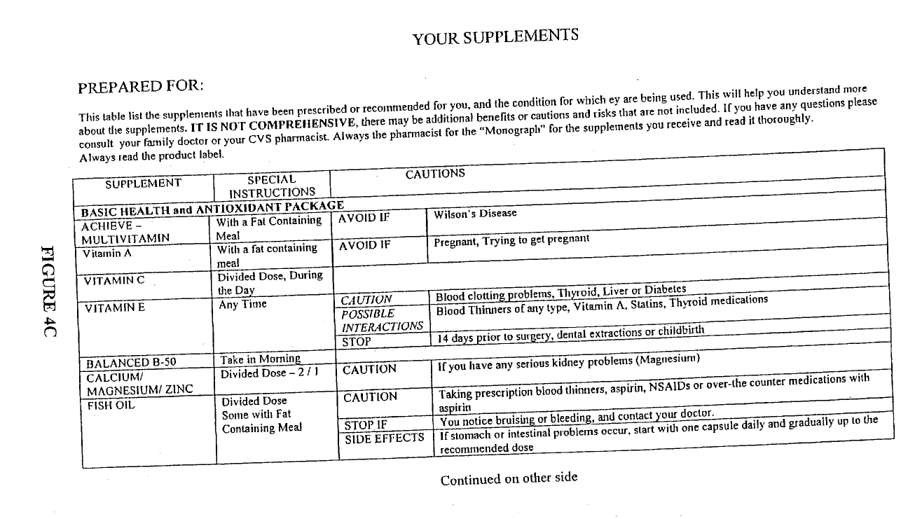

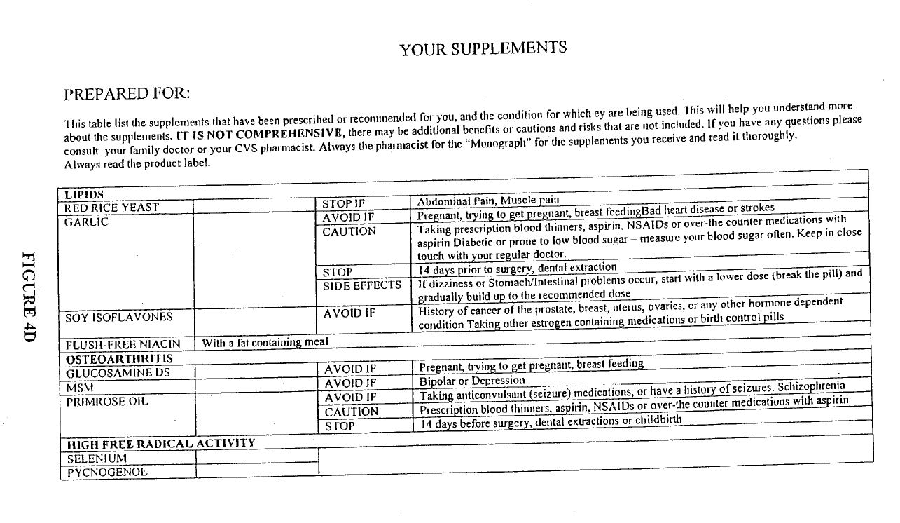

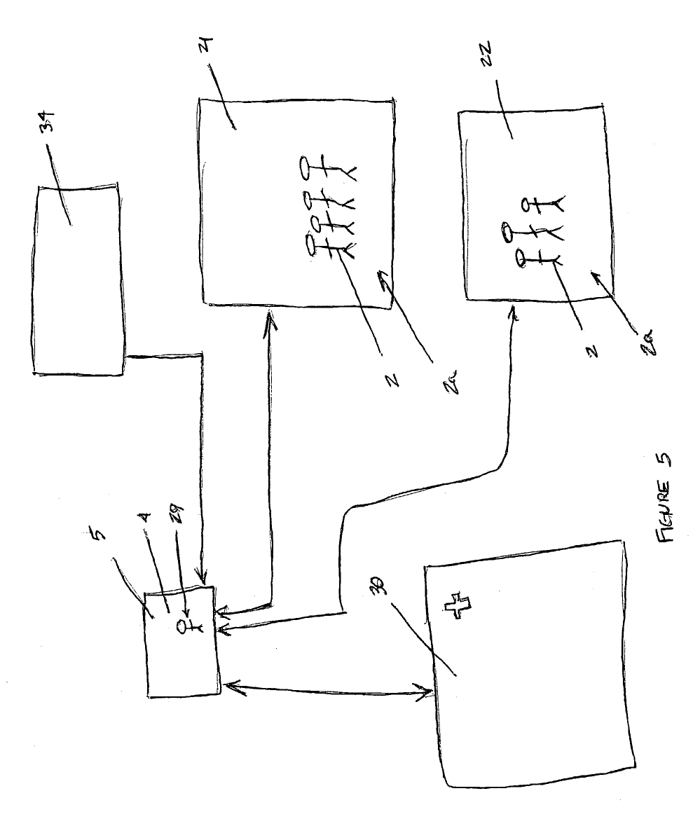

After the preventive care physician has developed an individualized preventive health care plan, the physician may communicate the plan to the participant. In the preferred embodiment, the prevent care physician may travel back to the place of normal business activity of the participant for presentation of the individualized preventive care plan. However, it is noted any person sufficiently trained in the medical arts to communicate the preventive care plan may travel to the place of normal business activity for presentation thereof to the participant. In an alternate embodiment, the same person trained to gather data in the first phases of the present method may also communicate the plan to the participant, which may include but is not limited to doctor's assistants, nurses and the like. Communicating the plan may include prescribing one or more non-prescription substances, such as vitamins and minerals as may be available from local pharmacy or drug store. Additionally, the plan may include an outline of exercise tailored for the specific needs of the individual. FIGS. 4 through 4d show an example of one preventive care prescription. Subsequently, the participant may be educated on the various aspects of their wellness condition. That is to say that the participant may be educated on how their present wellness condition came into being for future prevention thereof. Prescribing substances and activity may act to improve the health profile of the participant, although lifestyle choices of the participant may continue to lead the participant back toward a more negative health profile. Therefore, the prevent care plan educates the individual on how to maintain a more positive health profile or wellness condition and not just to restore or improve the participant's wellness condition. This may include the presentation of dietary facts related to eating choices, especially as they may relate to the family medical history of the participant. However, any aspect of educating the participant to the implementing the recommended plan or improving the wellness condition of the participant may be chosen with sound medical judgment as is appropriate for a preventive care wellness plan.

In this manner, the preventive care plan may be episodic in nature. That is to say that the preventive care physician may periodically return to the normal place of business activity to subsequently gather and test the participant's wellness condition again to see if the participant's wellness condition has improved or worsened. A new preventive care plan may be prescribed as related to the data amassed during the gathering and testing phase. It is noted that family medical history, as well as physiological data may have changed during the preventive care visits. Therefore, a completely new health profile may be developed in each preventive care visit made to the participant. In the preferred embodiment, the preventive care technician conducts the method as described above on an annual basis. In an alternate embodiment, the period of conducting the present method of providing preventive care may extend from six months to eighteen months. However, any period of performing the method of the present invention may be chosen with sound medical judgment.

With reference now to FIG. 5, a schematic representation of a preventive care entity is shown generally at 5. In the preferred embodiment, the preventive care entity 5 manages the details of providing preventive health care in the manner described above. The preventive care entity 5 may manage the preventive health care plan from a base location 4. That is to say that the preventive care entity 5 may have an office 4a that receives mail and phone calls and conducts normal business activities, including customer service functions, sales functions, accounting functions and the like. The preventive care entity 5 may also employ administration and technical staff as is appropriate for conducting business in the manner described above. The preventive care entity 5 may be comprised of any person, physician, hospital, organization or third party administrator that performs the functions of managing preventive health care plan.

As previously discussed, the preventive health care plan may be administered to the participant, which may be one individual person 2 from a group of people 2a. This includes persons both covered and not covered by a health insurance plan. In one embodiment, the preventive health care plan 10 is administered to a group of individuals covered for medical treatment of illness by an existing health care insurance plan. However, it is contemplated in another embodiment that the preventive health care plan may be administered by a non-insurance type organization. One example of such a group of people 2a may be the employees of a business 21. Another example of a group 2a may be the members of an organization 22, as in the case of a private club. The group 2a may conduct routine organizational activities at one or more locations, which may be the normal place of business. In other words, a company having employees may conduct business at an office or manufacturing facility. Alternately, a organization may hold meetings at a private club or a public lodge. In any case, the place that an organization conducts their normal or routine organizational activities will be construed to mean normal place of business activity. It is noted that the group of individuals may extend to include, for example, spouses or extended family members. In this manner, the normal place of business activity may include the home or work environment of the extended group members. It is additionally noted that the present invention is applicable to a group of people, whether or not the group formally congregates for normal business activity meeting or even has common organizational activity. In other words, the group of people 2a could be a conglomerate of individuals. One important aspect of providing preventive health care for a group of people is that preventive health care reduces costs associated with serious or major illnesses.

The preventive care entity 5 may contract with a business 21 or organization 22 to provide preventive health care to a group 2a of individuals, which may be members of the business 21 or organization 22. The organization, which may be an employer for example, may contract with the preventive care entity 5 to provide preventive health care for their employees independent from any existing traditional health care plan. In such an example, the organization 22 may underwrite all of the costs for providing preventive care for the purpose of saving costs associated with the reduction of illness experienced by the employees participating in the preventive care program. In another embodiment, the preventive care entity 5 may contract with an existing primary health care provider 30 to provide preventive health care as a supplemental program to an existing health care package. In this case, the primary health care provider 30 may underwrite all or a portion of the costs associated with providing preventive health care in anticipation of reducing health related costs for those participating on the preventive care program. The primary care provider 30 may chose to provide their services at a discount to those organizations participating in the preventive health care program which will reduce costs in the long term, ultimately saving the primary care provider money. In yet another embodiment, an insurance company may contract with the preventive care entity to provide the preventive care wellness program to organizations for which an insurance company 34 underwrites health care costs. The insurance company 34 may reduce health insurance premiums for the organization that participates because of the benefits of reduces costs associated with implementing the preventive care plan. In this way, a preventive care underwriting entity may contract with the preventive care entity to provide the preventive care plan to a preventive care user entity or entities. Any manner of contracting with organizations, individuals, insurance companies, health care providers or other entity may be chosen with sound business judgment as is appropriate for a preventive care wellness program.

With reference to FIG. 5a, in another embodiment of the present method of providing a preventive care plan, the preventive care entity 5 may contract with a supplier 38 of nutrient-type substances such as vitamins and minerals as prescribed by the preventive care physicians. The supplier may agree to provide such nutrient-type substances at a reduced for those participant's 2a involved in the preventive care plan. It is also contemplated that an insuring entity providing preventive care as a supplement to existing primary health care may also contract with the preventive care entity 5 to further underwrite a portion of the costs of supplying such nutrient-type substances. However any manner of providing discounts for participant's enrolled in the preventive care program may be chosen with sound business judgment.

The preferred embodiments have been described, hereinabove. It will be apparent to those skilled in the art that the above methods may incorporate changes and modifications without departing from the general scope of this invention. It is intended to include all such modifications and alterations in so far as they come within the scope of the appended claims or the equivalents thereof.

Having thus described the invention, it is now claimed:

I/we claim:

1. A method of reducing long term health care costs, comprising the steps of:
providing a preventive health care plan for a group of people employed by an employing entity at at least a first location, said plan including:
providing a preventive health care technician,
traveling to said at least a first location,
testing the wellness condition of at least a first member of said group of people at said at least a first location,
developing an individualized wellness plan for said at least a first member, wherein said wellness plan is developed responsive to the testing results, and,
implementing said wellness plan by said at least a first member, thereby improving the overall wellness condition of said group of people; and,
underwriting the associated costs of implementing said preventive health care plan, wherein when said overall wellness condition is improved the long term health care cost with respect to said group of people will be substantially reduced.

2. The method of claim 1, wherein in the step of implementing the wellness plan further comprises:
educating said at least a first member with respect to implementing the wellness plan.

3. The method of claim 1, wherein after the step of developing a wellness plan, the step further comprising:
underwriting at least a first portion of the cost of implementing the wellness plan.

4. The method of claim 3, wherein the step of underwriting at least a first portion of the cost of implementing the wellness plan includes:
providing at least a first discount to non-prescription substances.

5. The method of claim 4, wherein the step of underwriting at least a first portion of the cost of implementing the wellness plan includes:
providing at least a second discount to non-prescription substances underwritten by a supplier of said non-prescription substances.

6. A method of providing a supplemental preventive health maintenance plan to a health care insurance plan, the method comprising the steps of:
providing at least a first person having health care insurance as insured by an insuring entity for providing health care, wherein said at least a first person receives medical treatment from a primary health care giver, and wherein said insuring entity underwrites at least a portion of the costs of said medical treatment; and,
providing a supplemental preventive health care insurance plan, the plan including:
providing a preventive health care technician,
evaluating the wellness condition of said at least a first person,
developing an individualized wellness plan for said at least a first person, wherein said wellness plan is developed responsive to the testing results, and,
implementing said wellness plan by said at least a first person, thereby improving the overall wellness condition of said group of people.

7. The method of claim 6, further including the step of:
underwriting at least a first portion of the costs of providing said supplemental preventive health care insurance plan.

8. The method of claim 7, wherein the step of underwriting at least a first portion of the costs, includes:
providing a second insuring entity for underwriting at least a first portion of the costs of providing said supplemental preventive health care insurance plan.

9. The method of claim 6, wherein the step of providing at least a first person includes providing at least a first person having a primary place of business activity, and
wherein after the step of providing a preventive health care technician, the step further comprising:
traveling to said primary place of business activity.

10. A method of improving the wellness of an individual, the steps comprising:
providing a preventive care technician;
providing at least a first person having an individual wellness condition;
traveling to a place of normal activities for said at least a first person;
administering a wellness test to said at least a first person;
analyzing the results of the wellness test;
developing an individualized wellness plan for improving the wellness condition of said at least a first person, wherein said individualized wellness plan is developed responsive to the results of the wellness test;
presenting said individualized wellness plan to said at least a first person;
educating said at least a first person with respect to the implementing the plan; and,
implementing the individualized wellness plan, thereby improving the wellness condition of said at least a first person.

11. The method of claim 10, the steps further comprising:
periodically traveling to said place of normal activities;
administering a subsequent wellness test to said at least a first person;
analyzing the wellness condition of said at least a first person with respect to the results of said subsequent wellness test;
developing a modified individualized wellness plan for improving the wellness condition of said at least a first person, wherein said modified individualized wellness plan is developed responsive to the results of said subsequent wellness test;

12. The method of claim 11, wherein the step of periodically traveling includes periods ranging from 6 months to 18 months.

13. The method of claim 10, further comprises the step of:
presenting said results of said wellness test to a primary care physician of said at least a first person.

14. The method of claim 10, wherein the step of providing a preventive care technician includes providing a preventive care physician.

15. The method of claim 10, wherein the step of providing at least a first person having a wellness condition, said wellness condition includes the level of free radicals in the body of said at least a first person.

16. The method of claim 15, wherein the step of administering a wellness test, said wellness test includes a urine test for testing said level of free radicals in the body of said at least a first person.

17. The method of claim 16, wherein the step of developing an individualized wellness includes prescribing at least a first non-prescription substance to aid in the neutralization of said free radicals.

18. The method of claim 17, wherein the step of developing an individualized wellness includes prescribing a predetermined individualized activity plan for said at least a first person for use in reducing said level of free radicals.
